(19) United States
(12) Patent Application Publication
(10) Pub. No.: US 2025/0046869 A1
(43) Pub. Date: Feb. 6, 2025

(54) LIQUID ELECTROLYTE, AND RECHARGEABLE LITHIUM BATTERY INCLUDING THE SAME

(71) Applicants: Samsung SDI Co., Ltd., Yongin-si (KR); UNIST(ULSAN NATIONAL INSTITUTE OF SCIENCE AND TECHNOLOGY), Ulsan (KR)

(72) Inventors: Myungheui WOO, Yongin-si (KR); Hyejin PARK, Yongin-si (KR); Sanghoon KIM, Yongin-si (KR); Arum YU, Yongin-si (KR); Nam-Soon CHOI, Ulsan (KR)

(21) Appl. No.: 18/734,916

(22) Filed: Jun. 5, 2024

(30) Foreign Application Priority Data
Aug. 1, 2023 (KR) 10-2023-0100657

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/004

(57) ABSTRACT

A liquid electrolyte includes: a lithium salt; a non-aqueous organic solvent; and an additive, wherein the additive comprises a polymer represented by Chemical Formula 1:

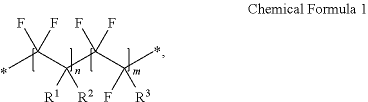

in Chemical Formula 1,
   R¹ to R³ are each independently hydrogen, fluorine, or a substituted or unsubstituted C1 to C10 alkyl group, and n and m are mole fractions, respectively, 50 mol %≤n≤90 mol %, 10 mol %≤m≤50 mol %.

### CROSS-REFERENCE TO RELATED APPLICATION

The present application claims priority to and the benefit of Korean Patent Application No. 10-2023-0100657, filed on Aug. 1, 2023, in the Korean Intellectual Property Office, the entire content of which is incorporated herein by reference.

### BACKGROUND

### 1. Field

One or more aspects of embodiments of this disclosure are directed toward a liquid electrolyte, and a rechargeable lithium battery including the same.

### 2. Description of the Related Art

A rechargeable lithium battery may be recharged and may have as much as three or more times higher energy density per unit weight than a comparable lead storage battery, nickel-cadmium battery, nickel hydrogen battery, nickel zinc battery and/or the like. The rechargeable lithium battery may be highly charged (e.g., may carry a relatively high charge) and thus, is commercially manufactured for laptops, cell phones, electric tools, electric bikes, and/or the like, and research on further improvement of energy density have been actively made or pursued.

A rechargeable lithium battery may be utilized by injecting an electrolyte into a battery cell including a positive electrode including a positive electrode active material that can intercalate and deintercalate lithium and a negative electrode including a negative electrode active material that can intercalate and deintercalate lithium.

A currently commercially available electrolyte may utilize an organic carbonate-based solvent to withstand a high operation voltage of rechargeable lithium batteries.

However, the organic carbonate-based solvent is highly volatile and flammable and has a relatively low flash point and thus may be gasified at a high temperature, which may make the battery swell up and a polyethylene (PE) separator melt down and shrink, thus causing safety issues for the rechargeable lithium battery.

However, despite attempts to solve these safety issues of the rechargeable lithium batteries via extensive research on separator, current collector, active material and/or battery management system (BMS), so long as highly flammable organic carbonate-based solvents are utilized, the issues cannot be easily solved yet,

Recently, the safety issues of the rechargeable lithium batteries have been actively discussed, e.g., for electric vehicles. In particular, there is a need or desire to fundamentally solve the issue of flammable solvents and to find a solution from the electrolyte perspective.

### SUMMARY

One or more aspects of embodiments of the present disclosure are directed toward a liquid electrolyte that can achieve excellent or suitable battery safety.

One or more aspects of the present embodiments are directed toward a rechargeable lithium battery including the liquid electrolyte.

According to one or more embodiments, a liquid electrolyte includes a lithium salt; a non-aqueous organic solvent; and an additive, wherein the additive includes a polymer represented by Chemical Formula 1.

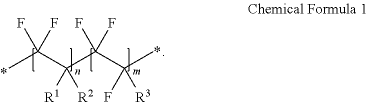

In Chemical Formula 1,

R¹ to R³ may each independently be hydrogen, fluorine, or a substituted or unsubstituted C1 to C10 alkyl group, and

n and m may be mole fractions, respectively, 50 mol %≤n≤90 mol %, 10 mol %≤m≤50 mol %.

According to one or more embodiments of the present disclosure, a rechargeable lithium battery may include a positive electrode including a positive electrode active material; a negative electrode including a negative electrode active material; and the liquid electrolyte according to the present embodiments.

The rechargeable lithium battery provides improved safety that can prevent or reduce battery short circuit, heat generation, and explosion by blocking or reducing ion conduction of the battery if (e.g., when) an issue occurs, suppressing or reducing swelling caused by evaporation of liquid electrolyte, and suppressing or reducing shrinkage of the separator.

### BRIEF DESCRIPTION OF THE DRAWINGS

FIGS. 1-4 are cross-sectional views schematically showing rechargeable lithium batteries according to one or more embodiments.

FIG. 5 is a graph showing specific capacity and coulombic efficiency according to cycle numbers during high temperature charging and discharging of rechargeable lithium battery cells.

FIG. 6 is a result graph showing the results of the hot-box test of the pouch full cell.

FIG. 7 is a graph showing the results of TGA analysis of a liquid electrolyte according to one or more embodiments.

FIG. 8 shows the results of measuring the cell resistance of rechargeable lithium battery cells maintained for 1 hour after reaching room temperature (25° C.) or high temperature (120° C.), respectively.

### DETAILED DESCRIPTION

Hereinafter, embodiments will be described in more detail so that those of ordinary skill in the art can easily implement them. However, this disclosure may be embodied in many different forms and is not construed as limited to the example embodiments set forth herein.

The terminology utilized herein is utilized to describe example embodiments only, and is not intended to limit the present disclosure. The singular expression includes the plural expression unless the context clearly dictates otherwise.

As utilized herein, “combination thereof” refers to a mixture, laminate, composite, copolymer, alloy, blend, reaction product, and/or the like of the constituents.

Herein, it should be understood that terms such as “comprises,” “includes,” or “has” are intended to designate the presence of an embodied aspect, number, operation (e.g., step, task, act, and/or the like), element, and/or a (e.g., any suitable) combination thereof, but it does not preclude the possibility of the presence or addition of one or more other features, numbers, operations, elements, and/or a (e.g., any suitable) combination thereof.

As utilized herein, if (e.g., when) a definition is not otherwise provided, a particle diameter may be an average particle diameter. This particle diameter refers to an average particle diameter (D50), which is a diameter of particles with a cumulative volume of 50 volume % in the particle size distribution. The average particle size (D50) can be measured by any suitable method, for example, by measuring with a particle size analyzer, a transmission electron microscope, and/or a scanning electron microscope. In some embodiments, a dynamic light-scattering measurement device may be utilized to perform a data analysis, and the number of particles is counted for each particle size range. From this, the average particle diameter (D50) may be relatively easily obtained through a calculation. A laser diffraction method may also be utilized to measure the average particle diameter (D50). When measuring by laser diffraction, the particles to be measured are dispersed in a dispersion medium and then introduced into a commercially available laser diffraction particle size measuring device (e.g., MT 3000 available from Microtrac) utilizing ultrasonic waves at about 28 kHz, and after irradiation with an output of 60 W, the average particle size (D50) based on 50% of the particle size distribution in the measuring device can be calculated.

In the drawings, the thickness of layers, films, panels, regions, and/or the like, are exaggerated for clarity and like reference numerals designate like elements throughout the specification, and duplicative descriptions thereof may not be provided. It will be understood that if (e.g., when) an element such as a layer, film, region, and/or substrate is referred to as being “on” another element, it can be directly on the other element (e.g., without any intervening elements therebetween) or intervening elements may also be present. In contrast, if (e.g., when) an element is referred to as being “directly on” another element, there are no intervening elements present.

In one or more embodiments, “layer” herein includes not only a shape formed on the whole surface if (e.g., when) viewed in a plan view, but also a shape formed on a partial surface.

Herein, “or” is not to be construed as an exclusive meaning, for example, “A or B” is construed to include A, B, A+B, and/or the like.

As used herein, the term “and/or” includes any and all combinations of one or more of the associated listed items.

Further, the use of “may” when describing embodiments of the present disclosure refers to “one or more embodiments of the present disclosure”

As used herein, the terms “use,” “using,” and “used” may be considered synonymous with the terms “utilize,” “utilizing,” and “utilized,” respectively.

As used herein, expressions such as “at least one of”, “one of”, and “selected from”, when preceding a list of elements, modify the entire list of elements and do not modify the individual elements of the list. For example, “at least one selected from among a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper,” “bottom,” “top” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

“Metal” is interpreted as a concept that includes ordinary metals, transition metals, and semi-metals.

As utilized herein, if (e.g., when) a definition is not otherwise provided, “substituted” refers to replacement of at least one hydrogen of a substituent or a compound by deuterium, a halogen group, a hydroxyl group, an amino group, an amine group, a nitro group, a silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, and/or a (e.g., any suitable) combination thereof.

In some embodiments, the “substituted” refers to replacement of at least one hydrogen of a substituent or a compound by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In some embodiments of the present disclosure, the “substituted” refers to replacement of at least one hydrogen of a substituent or a compound by deuterium, a halogen group, a C1 to C20 alkyl group, a C6 to C30 aryl group, a C1 to C10 fluoroalkyl group, or a cyano group. For example, the “substituted” refers to replacement of at least one hydrogen of a substituent or a compound by deuterium, a halogen group, a C1 to C5 alkyl group, a C6 to C18 aryl group, a C1 to C5 fluoroalkyl group, or a cyano group. In some embodiments, the “substituted” refers to replacement of at least one hydrogen of a substituent or a compound by deuterium, a cyano group, a halogen group, a methyl group, an ethyl group, a propyl group, a butyl group, a phenyl group, a biphenyl group, a terphenyl group, a trifluoromethyl group, or a naphthyl group.

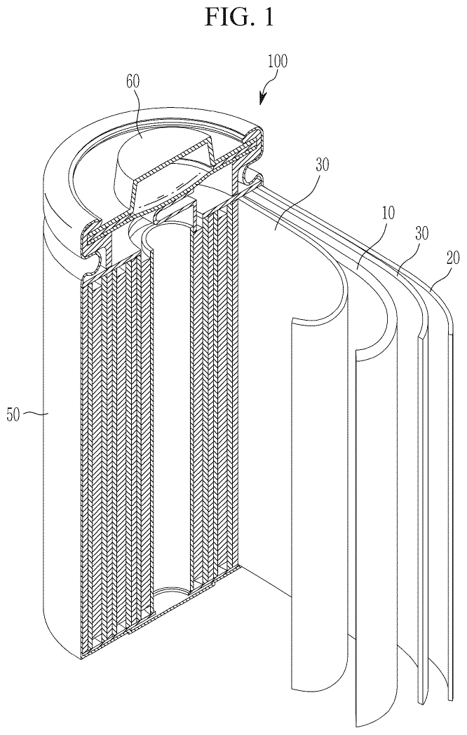

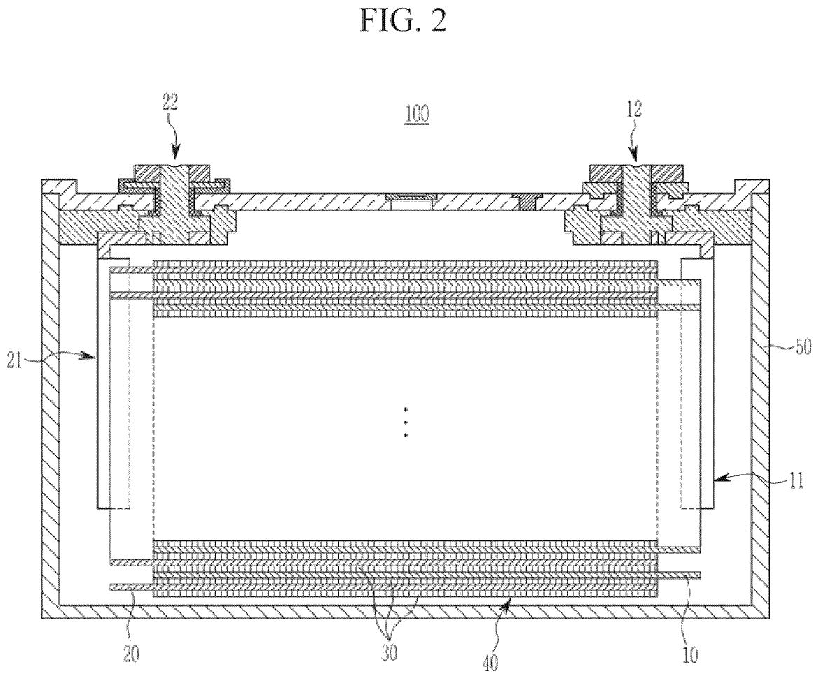

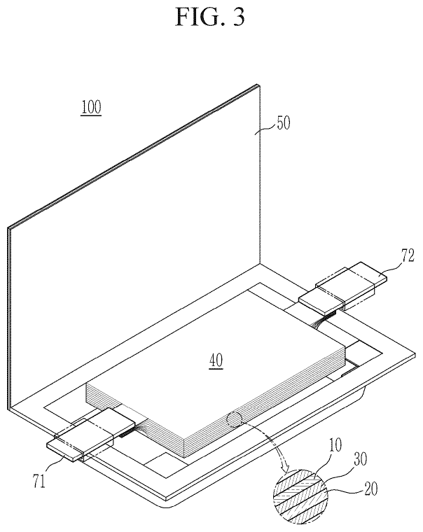

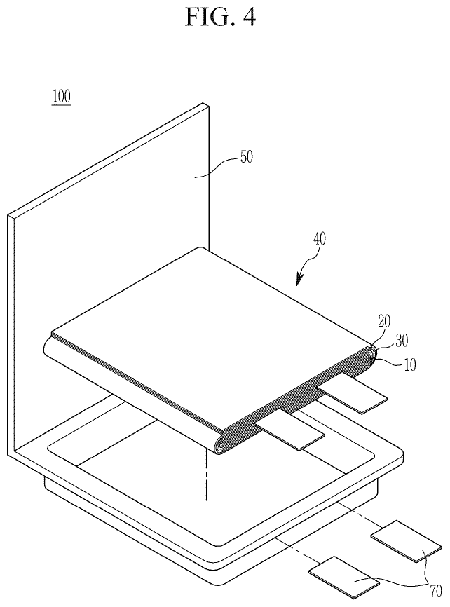

The rechargeable lithium battery may be classified into cylindrical, prismatic, pouch, coin-type or kind batteries, and/or the like depending on their shape. FIGS. 1 to 4 are schematic views illustrating rechargeable lithium batteries according to one or more embodiments. FIG. 1 shows a cylindrical battery, FIG. 2 shows a prismatic battery, and FIGS. 3 and 4 show pouch-type or kind batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with a liquid electrolyte. The rechargeable lithium battery 100 may include a sealing member 60 sealing the case 50, as shown in FIG. 1. In FIG. 2, the rechargeable lithium battery 100 may include a positive electrode lead tab 11, a positive terminal 12, a negative electrode lead tab 21, and a negative terminal 22. As shown in FIGS. 3 and 4, the rechargeable lithium battery 100 may include an electrode tab 70, which may be, for example, a positive electrode tab 71 and a negative electrode tab 72 serving as an electrical path for inducing (e.g., providing) the current formed in the electrode assembly 40 to the outside.

Hereinafter, an electrolyte according to one or more embodiments will be described.

The electrolyte according to one or more embodiments may be a liquid electrolyte including a lithium salt, a non-aqueous organic solvent, and an additive, wherein the additive includes a polymer represented by Chemical Formula 1.

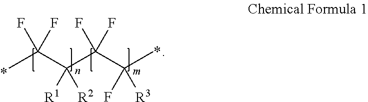

In Chemical Formula 1,

R¹ to R³ may each independently be hydrogen, fluorine, or a substituted or unsubstituted C1 to C10 alkyl group, and

n and m are mole fractions and are, respectively, 50 mol %≤n≤90 mol %, 10 mol %≤m≤50 mol %.

If (e.g., when) the polymer represented by Chemical Formula 1 is exposed to a high temperature of 100° C. or higher, it may be gelled by crystallization in a liquid electrolyte and thus may not only suppress or reduce gasification of the liquid electrolyte and thus expansion of the battery, but also suppress or reduce fire and explosion of the battery by blocking or reducing ionic and electronic conductions of the battery and preventing or reducing sharp energy release due to a direct contact (a short-circuit) of the positive and negative electrodes (e.g., through a mechanism of physically fixing the PE separator which melts and shrinks at about 140° C.) and results in improving safety of the battery.

In one or more embodiments, the polymer represented by Chemical Formula 1 is dispersed in the liquid electrolyte before any of the issues occur, such as a high temperature, an impact, and/or the like. Here, the liquid electrolyte in which the polymer represented by Chemical Formula 1 is included is different from a solid electrolyte that is formed at the electrolyte phase by polymerization of the polymer with a polymerization initiator.

Because the solid electrolyte is present in a solid state in a battery, the battery may exhibit a relatively low output and a short cycle-life due to relatively low ion conductivity. By comparing with comparative examples, a battery applied with the liquid electrolyte according to the present disclosure may exhibit significantly different effects.

For example, a ratio of n and m (n:m) may be about 80 mol %:about 20 mol % to about 60 mol %:about 40 mol %, or about 80 mol %:about 20 mol % to about 70 mol %:about 30 mol %.

The higher the content (e.g., amount) of the vinylidene fluoride structural unit in the polymer relative to the content (e.g., amount) of the trifluoroethylene structural unit, the more effective the improvement in battery stability are.

A molecular weight of the polymer may be about 100,000 g/mol to about 400,000 g/mol.

For example, the molecular weight of the polymer may be about 200,000 g/mol to about 400,000 g/mol.

The polymer may be in the form (or provide) of particles having an average particle diameter (that is, an average particle diameter (D50)) of about 10 nm to about 1 μm.

For example, an average particle diameter of the polymer may be about 10 nm to about 900 nm, about 10 nm to about 800 nm, about 10 nm to about 700 nm, or about 10 nm to about 600 nm.

For example, the average particle diameter of the polymer is about 30 nm to about 1 μm, about 50 nm to about 1 μm, about 100 nm to about 1 μm, about 100 nm to about 900 nm, about 100 nm to about 800 nm, about 100 nm to about 700 nm, or about 100 nm to about 600 nm.

The polymer may be in the form of particles, and if (e.g., when) the average particle size is within any of the above ranges, precipitation of the polymer in the liquid electrolyte can be alleviated or reduced, thereby reducing capacity degradation due to cycle repetition.

In some embodiments, R¹ to R³ in Chemical Formula 1 may each independently be hydrogen or a substituted or unsubstituted C1 to C5 alkyl group.

For example, the polymer may be poly(vinylidene fluoride-co-trifluoroethylene).

The polymer can be gelled at a temperature of about 100° C. to about 120° C.

For example, the polymer may be included in an amount of about 0.1 to about 15 parts by weight based on a total of 100 parts by weight of the liquid electrolyte.

For example, the polymer may be included in an amount of about 0.5 to about 15 parts by weight, for example, about 1 to about 15 parts by weight, or about 5 to about 15 parts by weight, based on a total of 100 parts by weight of the liquid electrolyte.

When the polymer content (e.g., amount) is in a range as described above, the rechargeable lithium battery with improved stability can be implemented by preventing or reducing an increase in resistance at high temperatures while ensuring (e.g., substantially maintaining) cycle-life characteristics and output characteristics.

The non-aqueous organic solvent serves as a medium for transmitting ions taking part in the electrochemical reaction of a battery.

The non-aqueous organic solvent may include a carbonate-based solvent, ester-based solvent, ether-based solvent, ketone-based solvent, alcohol-based solvent, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may include methyl acetate, ethyl acetate, n-propyl acetate, dimethyl acetate, methylpropionate, ethylpropionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In one or more embodiments, the ketone-based solvent may include cyclohexanone, and/or the like. The alcohol-based solvent may include ethanol, isopropyl alcohol, and/or the like, and the aprotic solvent may include nitriles (such as R¹—CN (wherein R¹ is a C2 to C20 linear, branched, or cyclic hydrocarbon group, and may include a double bond, an aromatic ring, or an ether bond, and/or the like), amides (such as dimethylformamide), dioxolanes (such as 1,3-dioxolane, and/or 1,4-dioxolane), sulfolanes, and/or the like.

The non-aqueous organic solvent may be utilized singularly (e.g., on its own) or in a mixture. When the non-aqueous organic solvent is utilized in a mixture, the mixture ratio may be controlled or selected in accordance with a desirable battery performance.

The non-aqueous organic solvent according to one or more embodiments may include cyclic carbonate and chain carbonate in a volume ratio of about 10:90 vol % to about 50:50 vol %.

For example, the non-aqueous organic solvent may include cyclic carbonate and chain carbonate in a volume ratio of about 10:90 vol % to about 40:60 vol %, for example, about 10:90 vol % to about 30:70 vol %, or about 10:90 vol % to about 25:75 vol %.

When the non-aqueous organic solvent of the above-mentioned composition is used, the viscosity of the liquid electrolyte increases as the polymer in the liquid electrolyte is gelled above a certain or set temperature, and as the resistance increases, the gelled polymer acts as an insulator and blocks or reduces ionic and electronic conduction of the battery, thus ensuring (or improving) the stability of the battery.

The liquid electrolyte may further include at least one of other additives selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

By further including any of the other additives mentioned above, cycle-life of the battery can be further improved and/or gases generated from the positive electrode and the negative electrode can be effectively or suitably controlled if (e.g., when) the battery is stored at high temperatures.

The other additive(s) may be included in an amount of about 0.2 to about 20 parts by weight, for example, about 0.2 to about 15 parts by weight or about 0.2 to about 10 parts by weight, based on a total of 100 parts by weight of the liquid electrolyte for a rechargeable lithium battery.

If the content (e.g., amount) of other additives is within any of the above ranges, the other additive(s) can contribute to improving battery performance by minimizing or reducing the increase in film resistance.

The lithium salt dissolved in the non-aqueous organic solvent supplies lithium ions in a battery, enables a basic operation of a rechargeable lithium battery, and improves transportation of the lithium ions between positive and negative electrodes. Examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

One or more embodiments of the present disclosure provide a rechargeable lithium battery including a positive electrode including a positive electrode active material; a negative electrode including a negative electrode active material; and the liquid electrolyte according to the present embodiments.

The positive electrode includes a positive electrode current collector and a positive electrode active material layer on the positive electrode current collector, and the positive electrode active material layer includes a positive electrode active material and may optionally further include a binder and/or a conductive material.

The positive electrode active material may include a compound (lithiated intercalation compound) that is capable of intercalating and deintercalating lithium. For example, a composite oxide of lithium and a metal selected from among cobalt, manganese, nickel, and combinations thereof may be utilized.

The composite oxide may be a lithium transition metal composite oxide. Examples of the composite oxide may include lithium nickel-based oxide, lithium cobalt-based oxide, lithium manganese-based oxide, lithium iron phosphate-based compound, cobalt-free nickel-manganese-based oxide, and/or a (e.g., any suitable) combination thereof.

For example, the following compounds represented by any one of the following Chemical Formulae may be utilized: LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O₂₋ₐDₐ (0.90≤a≤1.8, 0≤b≤0.5, 0≤c≤0.5, and 0<α<2); LiₐNi_{1-b-c}Mn_{b}X_{c}O₂₋ₐDₐ (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); and/or LiₐFePO₄ (0.90≤a≤1.8).

In the above chemical formulae, A is Ni, Co, Mn, and/or a (e.g., any suitable) combination thereof; X is Al, Ni, Co, Mn, Cr, Fe, Mg, Sr, V, a rare earth element and/or a (e.g., any suitable) combination thereof; D is O, F, S, P, and/or a (e.g., any suitable) combination thereof; G is Al, Cr, Mn, Fe, Mg, La, Ce, Sr, V, and/or a (e.g., any suitable) combination thereof; and L¹ is Mn, Al, and/or a (e.g., any suitable) combination thereof.

The positive electrode active material may be, for example, a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal(s) excluding lithium in the lithium transition metal composite oxide. The high-nickel-based positive electrode active material may be capable of realizing a relatively or suitably high capacity and can be applied to a high-capacity, high-density rechargeable lithium battery.

An amount of the positive electrode active material may be about 90 wt % to about 99.9 wt % based on 100 wt % of the positive electrode active material layer. Amounts of the binder and the conductive material may be about 0.1 wt % to about 5 wt %, respectively, based on 100 wt % of the positive electrode active material layer.

The binder serves to attach the positive electrode active material particles well or suitably to each other and also to attach the positive electrode active material well or suitably to the positive electrode current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, as non-limiting examples.

The conductive material may be utilized to impart conductivity (e.g., electrical conductivity) to the electrode. Any suitable material that does not cause chemical change (e.g., does not cause an undesirable chemical change in the rechargeable lithium battery) and conducts electrons can be utilized in the battery. Examples of the conductive material may include a carbon-based material such as natural graphite, artificial graphite, carbon black, acetylene black, ketjen black, a carbon fiber, a carbon nanofiber, and/or carbon nanotube; a metal-based material containing copper, nickel, aluminum, silver, and/or the like, in a form of a metal powder and/or a metal fiber; a conductive polymer such as a polyphenylene derivative; or a mixture thereof.

Al foil may be utilized as the positive electrode current collector, but the present disclosure is not limited thereto.

The negative electrode includes a negative electrode current collector and a negative electrode active material layer on the negative electrode current collector, and the negative electrode active material layer includes a negative electrode active material and may optionally further include a binder and/or a conductive material.

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, such as, for example. crystalline carbon, amorphous carbon and/or a (e.g., any suitable) combination thereof. The crystalline carbon may be graphite such as non-shaped (e.g., not in any specific shape), sheet-shaped, flake-shaped, sphere-shaped, and/or fiber-shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material and/or a Sn-based negative electrode active material. The Si-based negative electrode active material may include silicon, a silicon-carbon composite, SiOₓ (0<x<2), a Si-Q alloy (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof). The Sn-based negative electrode active material may include Sn, SnO₂, a Sn-based alloy, and/or a (e.g., any suitable) combination thereof.

The silicon-carbon composite may be a composite of silicon and amorphous carbon. According to one or more embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist (e.g., may be) dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material and/or the Sn-based negative electrode active material may be utilized in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well or suitably to each other and also to attach the negative electrode active material well or suitably to the negative electrode current collector. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and/or a (e.g., any suitable) combination thereof.

When an aqueous binder is utilized as the negative electrode binder, it may further include a cellulose-based compound capable of imparting suitable viscosity. The cellulose-based compound includes one or more selected from among carboxymethyl cellulose, hydroxypropylmethyl cellulose, methyl cellulose, and alkali metal salts thereof. The alkali metal may be Na, K, and/or Li.

The dry binder may be a polymer material capable of being suitably fiberized, and may be, for example, polytetrafluoroethylene, polyvinylidene fluoride, polyvinylidene fluoride-hexafluoropropylene copolymer, polyethylene oxide, and/or a (e.g., any suitable) combination thereof.

The conductive material is included to provide electrode conductivity, and any suitable electrically conductive material may be utilized as a conductive material unless it causes a chemical change (e.g., an undesirable chemical change) in the battery. Examples of the conductive material may be a carbon-based material such as natural graphite, artificial graphite, carbon black, acetylene black, ketjen black, a carbon fiber, a carbon nanofiber, a carbon nanotube, and/or the like; a metal-based material such as copper, nickel, aluminum, silver, and/or the like in a form of a metal powder and/or a metal fiber; a conductive polymer such as a polyphenylene derivative; or a mixture thereof.

The negative electrode current collector may include one selected from among a copper foil, a nickel foil, a stainless steel foil, a titanium foil, a nickel foam, a copper foam, a polymer substrate coated with a conductive metal, and/or a (e.g., any suitable) combination thereof, but the present disclosure is not limited thereto.

Depending on the type or kind of the rechargeable lithium battery, a separator may be present between the positive electrode and the negative electrode. The separator may include polyethylene, polypropylene, polyvinylidene fluoride, and/or a multilayer film of two or more layers thereof, and/or a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one selected from among polymer polyolefin (such as polyethylene and/or polypropylene), polyester (such as polyethylene terephthalate and/or polybutylene terephthalate), polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or may be a copolymer or mixture of two or more thereof.

The organic material may include a polyvinylidene fluoride-based polymer and/or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a (e.g., any suitable) combination thereof, but the present disclosure is not limited thereto.

The organic material and the inorganic material may be mixed in one coating layer, or a coating layer including an organic material and a coating layer including an inorganic material may be stacked.

Hereinafter, examples of the present disclosure and comparative examples are described. These examples, however, are not in any sense to be interpreted as limiting the scope of the present disclosure.

### Example: Manufacture of Rechargeable Lithium Battery Cells

### Example 1

LiNi_{0.8}Co_{0.1}Mn_{0.1}O₂ as a positive electrode active material, polyvinylidene fluoride as a binder, and acetylene black as a conductive material were mixed in a weight ratio of 97.5:1:1.5 and then, dispersed in N-methyl pyrrolidone to prepare positive electrode active material slurry.

The positive electrode active material slurry was coated on a 15 μm-thick Al foil and then, dried at 100° C. and pressed to manufacture a positive electrode.

Negative electrode active material slurry was prepared by mixing artificial graphite as a negative electrode active material, a styrene-butadiene rubber binder, and carboxymethyl cellulose in a weight ratio of 98:1:1 and then, dispersing the mixture in distilled water.

The negative electrode active material slurry was coated on a 10 μm-thick Cu foil and then, dried at 100° C. and pressed to manufacture a negative electrode.

The manufactured positive and negative electrodes were assembled with a 10 μm-thick polyethylene separator to manufacture an electrode assembly, and the following liquid electrolyte was implanted thereinto to manufacture a rechargeable lithium battery cell.

A composition of the liquid electrolyte was as follows.

### Liquid Electrolyte Composition

lithium salt: 1.15 M LiPF₆

Non-aqueous organic solvent: ethylene carbonate:ethylmethyl carbonate:Dimethyl carbonate (EC:EMC:DMC=volume ratio of 20:40:40)

### Additive:

(1) Polymer: Solvene®200/P200 (Mw=200,000, n:m=80 mol %:20 mol %; from Solvay S.A.) 15 parts by weight,

(2) 1 part by weight of vinylene carbonate (VC)

In the above composition of the liquid electrolyte, “parts by weight” refers to the relative weight of the additive to the total weight of 100 parts by weight of the liquid electrolyte (lithium salt and non-aqueous organic solvent) excluding the additive.

### Example 2

A rechargeable lithium battery cell was manufactured in substantially the same manner as in Example 1 except that Solvene®200/P400 (Mw=400,000, n:m=80 mol %:20 mol %; Solvay S.A.) was utilized instead of Solvene®200/P200.

### Example 3

A rechargeable lithium battery cell was manufactured in substantially the same manner as in Example 1 except that Solvene®250/P400 (Mw=400,000, n:m=75 mol %:25 mol %; Solvay S.A.) was utilized instead of Solvene®200/P200.

### Examples 4 and 5

Each rechargeable lithium battery cell was manufactured in substantially the same manner as in Example 1 except that the content (e.g., amount) of the polymer was respectively changed to 5 parts by weight and 10 parts by weight, instead of 15 parts by weight.

### Comparative Example 1

A rechargeable lithium battery cell was manufactured in substantially the same manner as in Example 1 except that the polymer was not utilized.

### Comparative Example 2

A rechargeable lithium battery cell was manufactured in substantially the same manner as in Example 1 except that a gel polymer electrolyte was prepared by adding a composition including 1 g of a polymer (Solvene®200/P200) and 0.5 g of a polymerization initiator (AIBN) to 95.5 g of a non-aqueous organic solvent (ethylene carbonate:ethylmethyl carbonate:dimethyl carbonate=20:40:40 in a volume ratio), in which 1.15 M LiPF₆ and 1 part by weight of vinylene carbonate (VC) were dissolved, and then, heating the mixture at 60° C. for 24 hours.

### Evaluation 1: Evaluation of High-Temperature (45° C.) Cycle-Life Characteristics

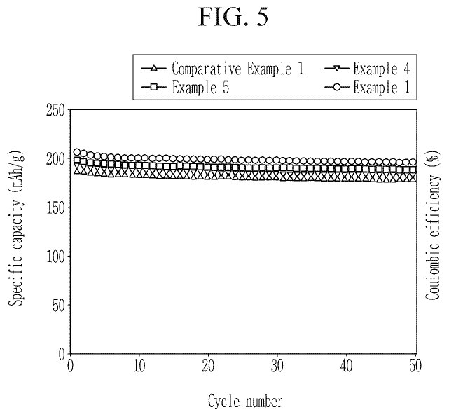

The rechargeable lithium battery cells according to Examples 1, 4, and 5 and Comparative Example 1 were 3 cycles charged and discharged at 1 C and continuously 50 cycles charged at 1.5 C and discharged at 1 C and then, measured with respect to discharge capacity and coulombic efficiency, and the results are shown in FIG. 5. Herein, a voltage range utilized for the charges and discharges was 3.0 V to 4.2 V (discharged down to 3.0 V and charged up to 4.2 V), and the evaluation was performed at 45° C.

FIG. 5 is a graph showing specific capacity and coulombic efficiency according to cycle numbers during high temperature charging and discharging of rechargeable lithium battery cells.

Referring to FIG. 5, the liquid electrolyte including the polymer of the present disclosure was capable of maintaining (e.g., maintained) the specific capacity and the coulombic efficiency substantially equally or at a higher level than the liquid electrolyte including no polymer. Accordingly, cycle-life characteristics of the rechargeable lithium battery cells including the polymer of the present disclosure may be expected to be not deteriorated but substantially maintained at an excellent or suitable level.

### Evaluation 2: Hotbox Evaluation

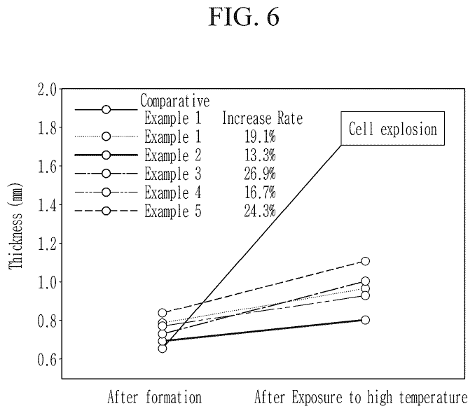

The pouch full cells of Examples 1 to 5 and Comparative Example 1 were charged to SOC 50 (e.g., state of charge 50%) (3.94 V) after a formation cycle and exposed to silicon oil at 130° C. for 5 minutes to compare degrees of volume expansion (thickness), and the results are shown in FIG. 6.

FIG. 6 is a result graph showing the results of the hot-box test of the pouch full cell.

Referring to FIG. 6, the pouch cell including no polymer (Comparative Example 1) burst due to volume expansion by (e.g., as a result of) gasification of the liquid electrolyte, but in the pouch full cells including the polymer of the present embodiments (Examples 1 to 5), gasification of the liquid electrolyte was suppressed or reduced, and the pouch full cells exhibited volume expansion alleviation. In one or more embodiments, if (e.g., when) the liquid electrolyte including the polymer was included, thermal safety was improved even in an environment of being stored at a high temperature.

### Evaluation 3: TGA (Thermo Gravimetric Analysis) Evaluation

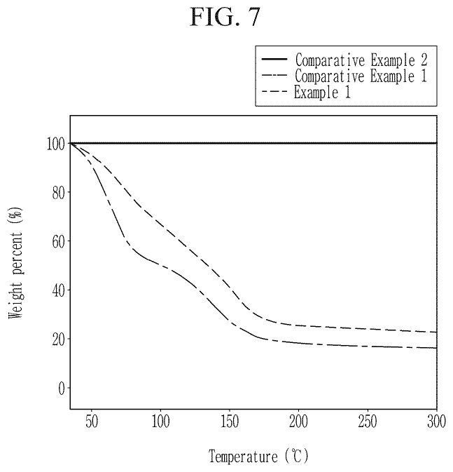

In order to measure a weight change of a material according to a temperature change, TGA analysis was performed on Example 1 and Comparative Examples 1 and 2, and the results are shown in FIG. 7.

FIG. 7 is a graph showing the results of TGA analysis of a liquid electrolyte according to one or more embodiments.

Referring to FIG. 7, as a result of the TGA analysis, in the liquid electrolyte of Example 1, mass at room temperature was halved due to gasification and thermal decomposition at 124° C., which is 42° C. higher than the temperature of 82° C. at which the mass of the liquid electrolyte (including no polymer) of Comparative Example 1 was halved. Without being bound by any particular theory, it is believed that the reason is that if (e.g., when) a liquid electrolyte in which the polymer was dissolved was introduced, the non-aqueous organic solvent participated in dissolution of the polymer to increase a boiling point due to Van der Waals force between polymer and non-aqueous organic solvent and thereby, delaying gasification of the liquid electrolyte at a high temperature and thus delaying explosion of the rechargeable lithium battery cells due to battery expansion and an increase in battery internal pressure.

In contrast, if (e.g., when) evaluating the polymer itself, because the mass halving does not occur in Comparative Example 2 to which a gel polymer electrolyte was applied, the effects of delaying gasification of the liquid electrolyte and delaying battery explosion due to the battery expansion and the increased internal pressure, akin to those desired in the present disclosure, were not expected.

### Evaluation 4: Evaluation of High-Temperature Direct Current Internal Resistance DC-IR Characteristics

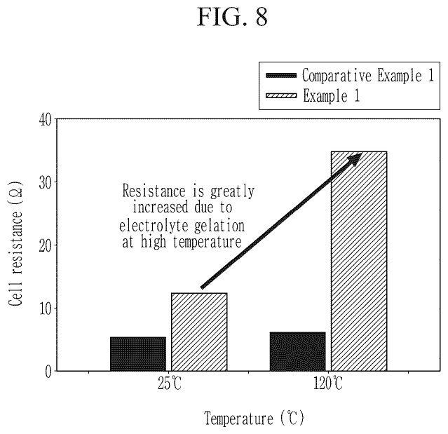

The rechargeable lithium battery cells of Example 1 and Comparative Example 1 were measured with respect to initial DC internal resistance (DCIR) by ΔV/ΔI (voltage change/current change) and then, remeasured with respect to room temperature (25° C.) DC internal resistance after making an internal maximum energy state of the rechargeable lithium battery cells to be a full-charge state (SOC 100%) and with respect to high temperature (120° C.) cell resistance if (e.g., when) maintained for 1 hour after reaching the high temperature (120° C.), and the results are shown in FIG. 8.

FIG. 8 shows the results of measuring the cell resistance of the rechargeable lithium battery cells maintained for 1 hour after reaching room temperature (25° C.) and high temperature (120° C.), respectively.

Referring to FIG. 8, if (e.g., when) a temperature of the rechargeable lithium battery cell of Example 1 into which a liquid electrolyte was introduced was increased to 120° C., resistance significantly increased at least in part due to gelation of the liquid electrolyte, and the gelled liquid electrolyte solution worked as an insulator between positive and negative electrodes, resultantly reducing sudden energy release, explosion, and/or a risk of fire due to a short circuit between the positive and negative electrodes.

Evaluation 5: Evaluation Direct Current Internal Resistance (DC-IR) Characteristics after being Left at High Temperature

The rechargeable lithium battery cells of Example 1 and Comparative Example 2 were measured with respect to initial DC internal resistance (DC-IR) by ΔV/ΔI (voltage change/current change) and then, remeasured with respect to high temperature (60° C.) DC internal resistance after making an internal maximum energy state of the rechargeable lithium battery cells to be a full-charge state (SOC 100%) and high temperature (60° C.) DC internal resistance after left at the high temperature (60° C.) for 5 days, and the DC internal resistance increase rate is calculated, and the results are shown in Table 1.

TABLE 1

| | Initial DC | Direct current internal | DC Internal |
|---|---|---|---|
| | internal | resistance after being | resistance |
| | resistance | left at 60° C. for 5 days | Increase |
| | (Ω) | (Ω) | rate (%) |
| Example 1 | 12.1 | 14.2 | 17.4 |
| Comparative | 13.5 | 27.5 | 103.7 |
| Example 2 | | | |

Referring to Table 1, during formation of a gel polymer (Comparative Example 2), the rechargeable lithium battery cell of Comparative Example 2 exhibited significant increase in resistance even at 50° C. to 60° C. (e.g., where a polymerization initiator worked) and exhibited higher DC internal resistance after being left at a high temperature than the rechargeable lithium battery cell of Example 1, and in addition, a significantly higher DC internal resistance increase rate due to an additional increase in DC internal resistance that was at least in part due to a substantially continuous cross-linking reaction than the rechargeable lithium battery cell of the Example.

In contrast, the polymer in the liquid electrolyte of the example was gelled at 100° C. to 120° C. and had almost no increase in DC internal resistance at 60° C. and exhibited relatively low DC internal resistance after being left at 60° C.

Accordingly, it is believed that the liquid electrolyte including the polymer additive according to the present disclosure was gelled due to crystallization of the polymer at a relatively high temperature, and the gelled liquid electrolyte formed a solid film, which worked as an insulator and blocked or reduced ion conductivity and electricity conductivity between the positive and negative electrodes, resultantly suppressing or reducing ignition and/or explosion of the rechargeable lithium battery cells.

In addition, it is believed that the gelled liquid electrolyte of the present embodiments suppressed or reduced shrinkage of the separator at a high temperature by physically bonding positive electrode-separator-negative electrode, and thus prevented or reduced a short circuit between the positive and negative electrodes.

Although the embodiments of the present disclosure have been described herein above, the present disclosure is not limited thereto, and can be implemented by one or more suitable modifications within the scope of the present detailed description, accompanying drawings, and claims and their equivalents.

### REFERENCE NUMERALS

100: rechargeable lithium battery 10: positive electrode
11: positive electrode lead tab 12: positive terminal
20: negative electrode 21: negative electrode lead tab
22: negative terminal 30: separator
40: electrode assembly 50: case
60: sealing member 70: electrode tab
71: positive electrode tab 72: negative electrode tab

What is claimed is:

1. A liquid electrolyte, comprising:
a lithium salt;
a non-aqueous organic solvent; and
an additive,
wherein the additive comprises a polymer represented by Chemical Formula 1: 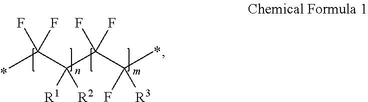
in Chemical Formula 1,
R¹ to R³ are each independently hydrogen, fluorine, or a substituted or unsubstituted C1 to C10 alkyl group, and
n and m are mole fractions, respectively, 50 mol %≤n≤90 mol %, 10 mol %≤m≤50 mol %.

2. The liquid electrolyte as claimed in claim 1, wherein
a ratio of n and m (n:m) are about 80 mol %:about 20 mol % to about 60 mol %:about 40 mol %.

3. The liquid electrolyte as claimed in claim 1, wherein
a molecular weight of the polymer is about 100,000 g/mol to about 400,000 g/mol.

4. The liquid electrolyte as claimed in claim 1, wherein
the polymer is in a form of particles having an average particle diameter of about 10 nm to about 1 μm.

5. The liquid electrolyte as claimed in claim 1, wherein
R¹ to R³ in Chemical Formula 1 are each independently hydrogen, or a substituted or unsubstituted C1 to C5 alkyl group.

6. The liquid electrolyte as claimed in claim 1, wherein
the polymer is poly(vinylidene fluoride-co-trifluoroethylene).

7. The liquid electrolyte as claimed in claim 1, wherein
the polymer is to be gelled at a temperature of about 100° C. to about 120° C.

8. The liquid electrolyte as claimed in claim 1, wherein
the polymer is in an amount of about 0.1 to about 15 parts by weight based on a total of 100 parts by weight of the liquid electrolyte.

9. The liquid electrolyte as claimed in claim 1, wherein
the non-aqueous organic solvent comprises cyclic carbonate and chain carbonate in a volume ratio of about 10:90 vol % to about 50:50 vol %.

10. The liquid electrolyte as claimed in claim 1, wherein
the liquid electrolyte further comprises at least one other additive selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

11. A rechargeable lithium battery comprising:
a positive electrode comprising a positive electrode active material;
a negative electrode comprising a negative electrode active material; and
the liquid electrolyte as claimed in claim 1.
